(19) United States
(12) Patent Application Publication
(10) Pub. No.: US 2004/0127262 A1
(43) Pub. Date: Jul. 1, 2004

(54) Cellular telephone

(76) Inventor: Yoshiharu Ohno, Tokyo (JP)

Correspondence Address: KODA & ANDROLIA, 2029 CENTURY PARK EAST, SUITE 1430, LOS ANGELES, CA, 90067-3024, US

(21) Appl. No.: 10/474,160

(22) PCT Filed: May 28, 2002
(86) PCT No.: PCT/JP02/05135

(30) Foreign Application Priority Data
May 31, 2001 (JP) 2001-164560

(51) Int. Cl. H04M 1/00; H04B 1/38

(52) U.S. Cl. 455/566; 455/550.1; 455/575.1

(57) ABSTRACT

Provided is a portable telephone device which allows the user to obtain a horizontally elongated display panel by taking simple procedures, without increasing the overall size of the device for the purpose. The portable telephone device comprises a display portion connected freely rotatably to a keyboard portion such that a display panel changes its shape from a vertically elongated one to a horizontally elongated one and vice versa according to the rotation angle of the display portion with respect to the keyboard portion. The user, when he/she wants to collect visual information via the display panel, only rotates the display portion with respect to the keyboard portion, to thereby obtain a horizontally elongated display panel.

With a portable telephone device wherein a display portion (2) is connected freely rotatably to a keyboard portion (1), the display portion (2) overlaps partially or as a whole with the keyboard portion (1). The display portion (2) is connected freely rotatably to the keyboard portion (1) via a rotational axis such that a display panel changes its shape with respect to the keyboard portion (1) from a vertically elongated one to a horizontally elongated one and vice versa according to the rotation angle of the display portion (2) with respect to the keyboard portion (1). When the display portion (2) completely overlaps with the keyboard portion (1), the display panel is vertically elongated. When the display portion (2) overlaps with the keyboard portion (1) only at the rotational joint, the display panel is horizontally elongated.

### TECHNICAL FIELD

The present invention relates to the structure of a portable telephone device, particularly to its display portion.

### BACKGROUND ART

Portable telephone devices including personal handyphone systems (PHS) act as a mobile substitute for common telephone systems installed in individual houses, and come to have such widely varied functions that they currently spread as a common electronic appliance among people over the world. Originally, portable telephone devices were developed as a machine for verbal communication. However, with the recent rapid development of electronics technologies, the body of a portable telephone device becomes compact, and its functions and performance are markedly improved. Indeed, portable telephone devices capable of achieving multiple functions become available in the market.

Among such portable telephone devices, some allow users, for example, not only to make verbal communications but also to exchange e-mails, while others have a colorful liquid crystal display which also acts as an element of a digital camera. As seen from these tendencies, the portable telephone device, which originally started as a machine for verbal communication, develops into a multi-functional machine which not only allows the user to make verbal communication but also to send/receive still images via a network system. It is expected from these tendencies that, with the next generation portable telephone device, the user will find more pleasure in sending/receiving animated images as well as still images via a network system than in verbal communication, and the services offered via portable telephone devices will put more emphasis on visual information such as distribution of multi-media programs, live broadcasting of entertainments and sports as well as video telephone and video conference.

There are various types of portable telephone devices. The basic structure of a portable telephone device, however, consists of a keyboard portion 1 on which operation buttons including ten keys and function keys are arranged in arrays, and a display portion 2 including a liquid crystal display (LCD) panel as shown in FIG. 9.

Ordinarily, a speech receiving portion 3 is placed at the bottom end of keyboard portion 1 while a speech delivering portion 4 is placed above the display portion 2.

It should be added here that there is a folded type portable telephone device (not illustrated) which has been introduced so as to compact the body of the device: two housings to enclose the keyboard portion 1 and display portion 2 are separately prepared, and the two housings enclosing the respective portions are connected via a hinge.

To comply with the current trend (tendency) mentioned above where more emphasis is put on the exchange of visual images than on verbal communication, new portable telephone devices should have an enlarged display portion 2 as compared with conventional devices, to enhance its visibility. However, since the physical dimension of display portion 2 is restricted by its relation with the keyboard portion 1 which usually takes a vertically elongated rectangular shape, the display portion 2 must also have a vertically elongated rectangular shape, that is, its shape is subject to limitations imposed by the dimension of keyboard portion 1 or of the device.

To the viewer, when two screens have the same area, images on a wide screen are more natural and impressive than those on a long screen. Indeed, images delivered via live broadcasting on a wide screen are more lively and preferable to the viewer than those on a long screen, regardless of whether the images are displayed on the screen of a television, video, car navigation system, or the like.

Therefore, the display portion should preferably have a horizontally elongated display panel. One of the easily conceivable methods for providing a portable telephone device which is usually equipped with a vertically elongated display panel, with a horizontally elongated display panel is to increase the width of the body of the device. However, according to this method, the overall size of the device is also increased which is contrary to the fundamental design concept governing the production of portable telephone devices, i.e., light-weight and compact size.

The object of the invention is to provide a portable telephone device relieved of the problems mentioned above encountered with conventional portable telephone devices, that is, a portable telephone device which allows the user to obtain a horizontally elongated display panel by taking simple procedures without requiring the overall size of the device to be increased.

### DISCLOSURE OF THE INVENTION

To attain the above object, a first aspect of the invention is to provide a portable telephone device comprising a display portion connected freely rotatably to a keyboard portion, wherein the display portion overlaps with the keyboard portion partially or as a whole; the display portion is rotatably connected via a rotational axis to the keyboard portion such that a display panel changes its shape with respect to the keyboard portion from a vertically elongated one to a horizontally elongated one and vice versa according to the rotation angle of the display portion with respect to the keyboard portion; and when the display portion completely overlaps with the keyboard portion, the display panel is vertically elongated, and when only the proximal end of the display portion overlaps with the upper end of the keyboard portion via the rotational axis, the display panel is horizontally elongated.

A second aspect of the invention is to provide a portable telephone device with a keyboard portion in which operation buttons including ten keys are arranged in vertical columns and horizontal rows, wherein the buttons are arranged in horizontal rows such that a line connecting anyone horizontal row of buttons forms an upward or downward slope with respect to the bottom line of the keyboard portion.

A third aspect of the invention is to provide a portable telephone device wherein a display portion overlaps with a keyboard portion with the face of the former contacting with the back of the latter when overlapping occurs at the entire surfaces of the two portions; the keyboard portion has a small display window for displaying a phone number or the like; the display portion is connected via a rotational axis to the keyboard portion, and when the display portion is rotated around the rotational axis so that a display panel changes its shape with respect to the keyboard portion from a vertically elongated one to a horizontally elongated one, overlapping becomes partial, that is, overlapping occurs only at a joint section of the two portions; and arrays of buttons forming the core of the keyboard portion are placed below the joint section.

A fourth aspect of the invention is to provide a portable telephone device wherein a speech receiving portion is placed close to the lower end of a keyboard portion, and a through-hole is formed close to the distal end of a display portion, such that when the two portions are completely overlapped, the speech receiving portion corresponds in position with the through-hole. A fifth aspect of the invention is to provide a portable telephone device wherein a display portion is connected via a rotational axis to a keyboard portion such that, when complete overlapping occurs between the two portions, the display portion overlaps with the keyboard portion with the face of the former contacting with the back of the latter, and when the display portion is rotated around the rotational axis so that a display panel changes its shape with respect to the keyboard portion from a vertically elongated one to a horizontally elongated one, overlapping becomes partial, that is, overlapping occurs only at a joint section of the two portions; and the display panel forming the core of the display portion is placed distal to the joint section.

A sixth aspect of the invention is to provide a portable telephone device wherein a display portion is connected to a keyboard portion via a rotational axis which forms the core of a joint section of the two portions; and principally the rotational joint is formed by engaging an annular projection with a central mortise attached to either of the two portions with a corresponding annular recess with a central tenon formed on the other portion, after placing the annular projection opposite to the annular recess and the central mortise to the central tenon respectively, and specifically the joint is formed by preparing a circular seat having an upright bolt with a male thread at its center, drilling a hole with a female thread through the central axis of the tenon, fitting the annular projection with the central mortise to the annular recess with the central tenon, placing the circular seat on the back of the display portion at a position opposite to the mortise such that the bolt projects along the central axis within the internal cavity of the mortise, and screwing the bolt with a male thread into the hole with a female thread, so as to firmly fasten the display portion to the keyboard portion and to allow the display portion to freely rotate with respect to the keyboard portion with the central axis of the tenon as the axis of rotation.

According to a portable telephone device of the invention described in Claim 1, a display portion is connected freely rotatably to a keyboard portion such that a display panel changes its shape with respect to the keyboard portion from a vertically elongated one to a horizontally elongated one and vice versa according to the rotation angle of the display portion with respect to the keyboard portion. When the user wants to collect visual information on the display panel, he/she rotates the display portion with respect to the keyboard portion until the display panel changes its shape with respect to the keyboard portion from a vertically elongated one to a horizontally elongated one.

According to a portable telephone device of the invention described in Claim 2, in addition to the features described in the foregoing paragraph following features are insured: when a display portion is rotated to a position where a display panel is horizontally elongated with respect to a keyboard portion, the keyboard portion, keeping its vertical disposition, is deprived of a large part of its contact with the display portion, and thus can be easily gripped by hand which facilitates the manipulation of operation buttons. Moreover, since operation buttons including ten keys are arranged in horizontal rows such that a line connecting any one horizontal row of buttons forms a slope with respect to the bottom line of the keyboard portion, the user can easily manipulate the buttons using only his/her thumb while gripping the keyboard with the remaining fingers and palm.

According to a portable telephone device of the invention described in Claim 3, a keyboard portion is always on the surface regardless of whether a display portion is shifted to an extended position or to a folded position which allows the user to easily manipulate operation buttons on the keyboard portion. Moreover, since the keyboard portion has a small display window for displaying a phone number or the like, the user can achieve a minimum function such as telephone communication while keeping the display portion placed behind the keyboard portion with a display panel vertically elongated.

According to a portable telephone device of the invention described in Claim 4, even when a display portion is rotated with respect to a keyboard portion to a position where a display panel becomes horizontally elongated, the two portions overlap with each other via a joint section which helps to compact the overall size of the device. Moreover, since buttons forming the core of the keyboard portion are arranged below the joint section, key manipulation is not disturbed by rotation or positioning of the display portion.

According to a portable telephone device of the invention described in Claim 5, since a speech receiving portion is placed close to the lower end of a keyboard portion, and a through-hole is formed close to the distal end of a display portion such that when the two portions are completely overlapped, the speech receiving portion corresponds in position with the through-hole, both the frontal and rear aspects of the speech receiving portion are exposed even when the display portion is placed behind the keyboard portion with a display panel being vertically elongated, transmission of speaking voice to the speech receiving portion is not disturbed.

According to a portable telephone device of the invention described in Claim 6, even when a display portion is rotated with respect to a keyboard portion to a position where a display panel becomes horizontally elongated, the two portions overlap with each other via a joint section which helps to compact the overall size of the device. Moreover, since the display panel forming the core of the display portion is placed distal to the joint section, visibility of the display panel is not disturbed by rotation or positioning of the display portion.

According to a portable telephone device of the invention described in Claim 7, a display portion is connected to a keyboard portion via a rotational axis, and following means are employed for stabilizing the rotational connection. Rotational connection is achieved by engaging an annular projection with a central mortise attached to either of the two portions with a corresponding annular recess with a central tenon formed on the other portion with the central axis of the central tenon serving as an axis of rotation. The connection is further secured by preparing a circular seat having an upright bolt with a male thread at its center, placing the circular seat on the back of the display portion at a position opposite to the mortise such that the bolt projects along the central axis within the internal cavity of the mortise, and screwing the bolt with a male thread into a hole with a female thread formed along the central axis of the tenon, with the seat carrying the bolt supporting the display portion from its backside, thus preventing the rotational joint from being subject to looseness.

### BRIEF DESCRIPTION OF THE DRAWINGS

FIG. 1 is an anterior view of a portable telephone device representing a first embodiment of the invention being in an extended state.

FIG. 2 is an anterior view of the portable telephone device representing the first embodiment of the invention being in a folded state.

FIG. 3 is a lateral view of the longitudinally sectioned portable telephone device representing the first embodiment of the invention in the folded state.

FIG. 4 is an exploded perspective view of the portable telephone device representing the first embodiment of the invention.

FIG. 5 is an anterior view of a.portable telephone device representing a second embodiment of the invention being in an extended state.

FIG. 6 is an anterior view of the portable telephone device representing the second embodiment of the invention being in a folded state.

FIG. 7 is an anterior view of the keyboard portion of the portable telephone device representing the second embodiment of the invention.

FIG. 8 is a lateral view of the longitudinally sectioned portable telephone device representing the second embodiment of the invention.

FIG. 9 is an anterior view of a conventional portable telephone device.

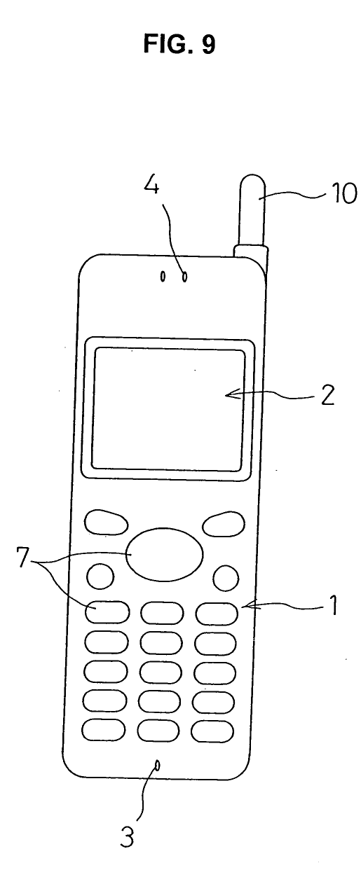

### BEST MODE FOR CARRYING OUT THE INVENTION

Preferred embodiments of the invention will be detailed below with reference to the attached drawings.

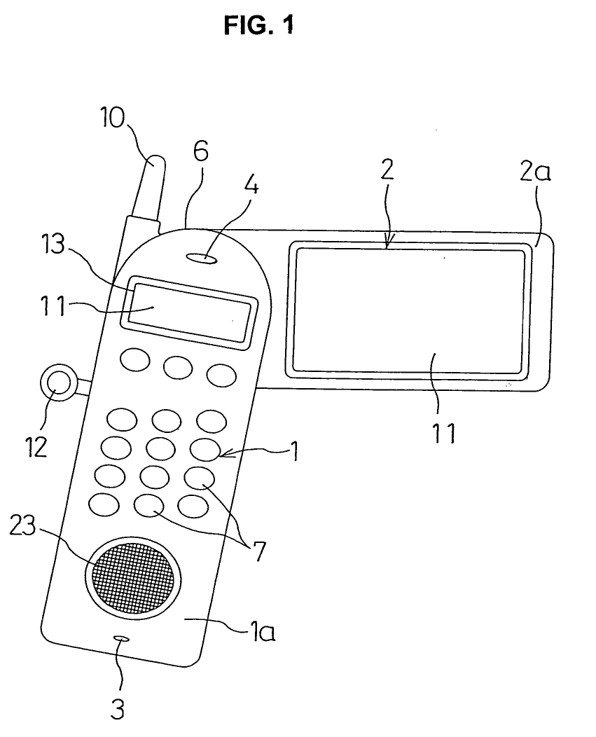

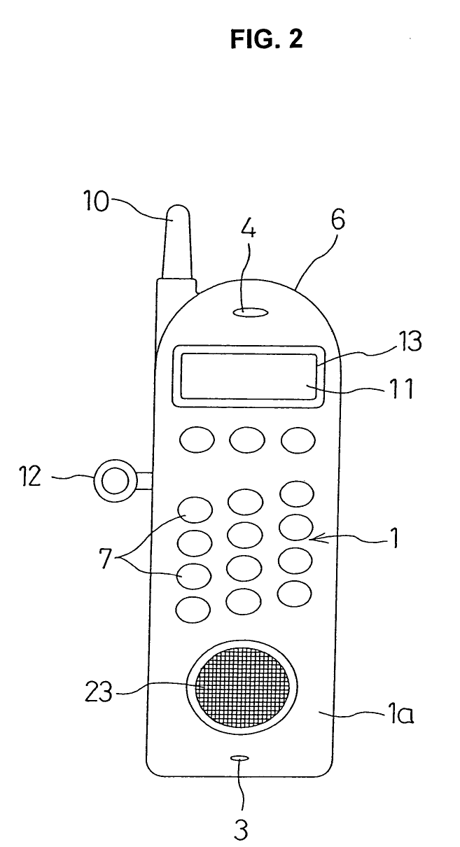

FIG. 1 is an anterior view of a portable telephone device representing a first embodiment of the invention in an extended state, while FIG. 2 is an anterior view of the same portable telephone device in a folded state. The portable telephone device comprises a keyboard portion 1 consisting of operation buttons 7 arranged in arrays, and a display portion 2 consisting of an LCD panel 11. It further includes a speech receiving portion 3 close to the bottom end of the keyboard portion 1 and a speech delivering portion 4 upwards on the keyboard portion 1 similarly to a conventional portable telephone device. The number 10 in the figure represents an antenna.

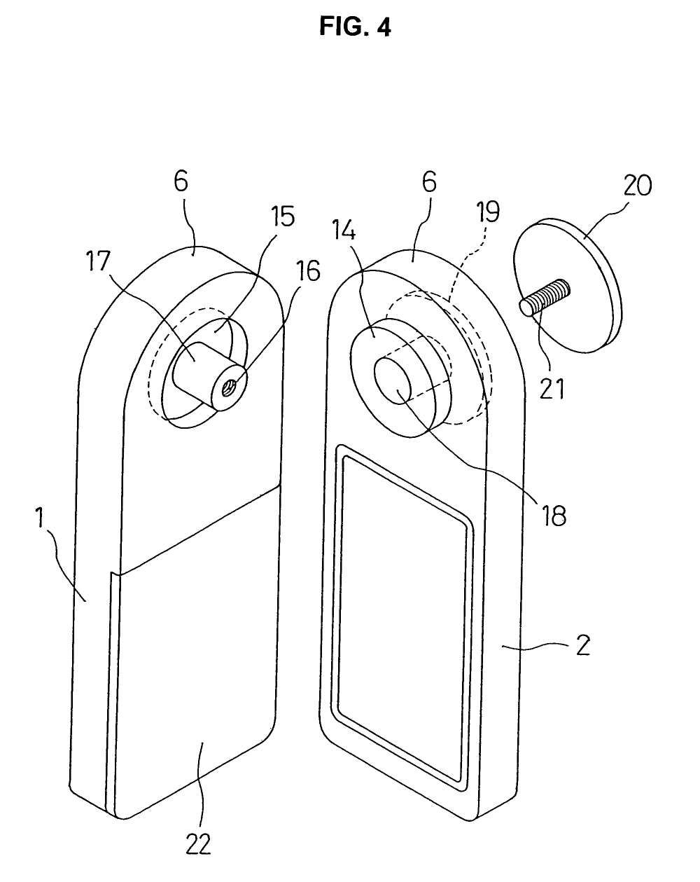

The keyboard portion 1 and display portion 2 are obtained by transferring necessary electronic elements into flat housings 1a and 2a, respectively. A battery 22 (see FIG. 4) is attached either to the keyboard portion 1 or to the display portion 2 (battery is placed backward in the keyboard portion 1 in the particular embodiment shown in the figure).

In the embodiment shown in the figure, the housing 1a carrying the keyboard portion 1 and the housing 2a carrying the display portion 2 have practically the same shape. Particularly, the top end of the housing 1a and the proximal end of the housing 2a have the same arc contour 6 around a center at which a rotational axis resides. Thanks to this arrangement, even when the display portion 2 is rotated with respect to the keyboard portion 1 such that the display panel 11 becomes horizontally elongated with respect to the keyboard portion, its proximal end having the arc contour 6 closely overlaps with the top end of the keyboard portion 1 having the same arc contour 6 without extending any portion thereof out of the overlapped area.

In addition, the operation buttons 7 constituting the core of keyboard portion 1 have an elliptical face, and are arranged in vertical columns and horizontal rows. Particularly, with regard to their horizontal arrangement, the buttons are disposed such that a line connecting any one horizontal row of buttons forms an upward or downward slope (upward in the embodiment shown in FIG. 1) with respect to the bottom line of the keyboard portion 1.

The display portion 2 is connected freely rotatably to the keyboard portion 1 via a rotational axis, and can overlap with the keyboard portion 1 with its face contacting with the back of the latter.

When the display portion 2 overlapping with the keyboard portion 1 with its face contacting with the back of the latter, is rotated with respect to the keyboard portion 1 such that the display panel changes its shape with respect to the keyboard portion from a vertically elongated one to a horizontally elongated one, overlapping becomes partial, that is, overlapping occurs only at a joint section of the two portions, and the display panel forming the core of the display portion is placed distal to the joint section.

The keyboard portion 1 has a small display window 13 distinct from the LCD panel 11 of display portion 2, which includes an LCD panel similarly to the display panel 11 of display portion 2.

The small display window may include a display panel sufficiently large to exhibit a series of alphanumeric symbols such as a phone number. The keyboard portion 1 also has a speaker 14. The speaker 14 is preferably so powerful as to permit the user, when it delivers music, to enjoy the music.

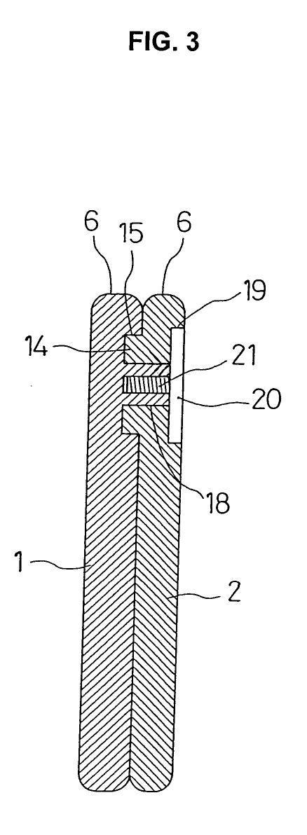

The display portion 2 is connected freely rotatably to the keyboard portion 1 via a rotational axis. The structure of the rotational joint will be described. As shown in FIGS. 3 and 4, the display portion 2 and keyboard portion 1 overlap with each other when the device is in a folded state, and the rotational joint is formed by engaging an annular projection 14 with a central mortise attached to either of the two portions (to the display portion 2 in the particular embodiment shown in the figures) with a corresponding annular recess 15 with a central tenon formed on the other portion (on the keyboard portion 1 in the embodiment shown in the figures). The joint is further strengthened by screwing a bolt in a threaded hole. For this purpose, a hole with a female thread 16 is drilled through the central axis of the cylindrical tenon 17 at the center of annular recess 15.

The mortise or through-hole 18 to receive the tenon 17 is formed at the center of the annular projection 14. The hole penetrates the display portion 2 (with reference to the embodiment shown in the figures). Around the backside opening of the through-hole 18 there is formed a circular flat recess 19.

When the annular projection 14 is inserted into the annular recess 15, concurrently the mortise or through-hole 18 receives the tenon 17, and the end surface of the tenon appears at the external opening of the through-hole 18. A disc-shaped seat 20 carrying an upright bolt 21 at its center is placed against the backside of the display portion 2 so that the distal end of the bolt 21 faces the exposed end surface of the tenon 17. The bolt 21 with a male thread is then screwed into the hole with a female thread formed through the central axis of the tenon, thereby fastening the display portion 2 to the keyboard portion 1.

When the display portion 2 is fastened by screwing to the keyboard portion 1, the annular projection 14 engages with the annular recess 15. Then, the display portion 2 can freely rotate with respect to the keyboard portion while engagement of the annular projection 14 with the annular recess 15 is securely maintained. The disc-shaped seat 20 supporting the bolt 21 is received by the circular flat recess 19.

Electrical connection of the display portion 2 with the keyboard portion 1 may be achieved by any appropriate means. The rotational joint constituted by an axis joining the display portion to the keyboard portion may have a structure enabling the electrical connection of the two portions.

Next, use of a portable telephone device of the invention will be described. When the device is used for ordinary telephone communication which does not require viewing of the display panel of the display portion 2, the display portion 2 is allowed to overlap with the keyboard portion 1 and the display panel is vertically elongated as shown in FIG. 2. Then, the user talks with a thirty party on the other end of the line using the speech receiving portion 3 and speech delivering portion 4. In this use, the minimum necessary information for telephone communication such as a phone number is displayed on the small display window 13.

When the user wants to use the device as a tool for connecting to the Internet or watching a TV program, that is, for watching images on a sufficiently large display panel, he/she may rotate the display portion 2 with respect to the keyboard portion 1. The display portion 2 rotates about 90° with respect to the keyboard portion 1 to cause the LCD panel 11 to be horizontally elongated as shown in FIG. 1.

As mentioned above, the display portion 2 can be extended 90° or more with respect to the keyboard portion 1 until the LCD panel 11 becomes horizontally elongated. When the display portion 2 takes a most extended position where the display panel is horizontally elongated, or the angle the display portion forms with the keyboard portion is close to a rectangle, the device takes a pistol-like form: the display portion corresponds with the barrel of a pistol while the keyboard portion with its handle. If the user grips the device like a pistol, he/she may hold the display panel 11 at a position easily visible to him/her.

When the display portion 2 is displaced to an extended position to cause thereby the display panel to be horizontally elongated, the keyboard portion 1 which remains vertical serves as a handle by which the user can easily grip the device while keeping the display panel horizontally elongated. Moreover, while gripping the device in this manner, the user can easily manipulate the buttons using only his/her thumb, because the operation buttons 7 including ten keys are arranged horizontally such that a line connecting any one horizontal row of buttons forms a slope with respect to the bottom line of the keyboard portion 1.

The portable telephone device may incorporate a digital camera. In this case, the camera is preferably installed in the housing 1a carrying the keyboard portion 1. The aperture 12 of the digital camera should be positioned such that it does not intrude the surface area of display portion 2, even when the display position 2 is shifted in a most extended position. The aperture 12 of the digital camera may face backward instead of forward.

The rotational joint connecting freely rotatably the display portion 2 to the keyboard portion 1 may include a spring-based lock mechanism which allows the display portion 2 to be locked when it completely overlaps with the keyboard portion 1, or when it is fully extended to a position where the display panel becomes horizontally elongated. In combination with the lock mechanism, a release button should be added to release the lock mechanism at will. When the user depresses the button, the lock mechanism is released, the display portion 2 is rotated 90° with respect to the keyboard portion 1 due to spring action, and the display panel becomes horizontally elongated as shown in FIG. 1. To return the display portion 2 to the original position, it is only necessary to flex by hand the extended display portion 2 towards the keyboard portion 1 until the display portion 2 overlaps with the keyboard portion 1.

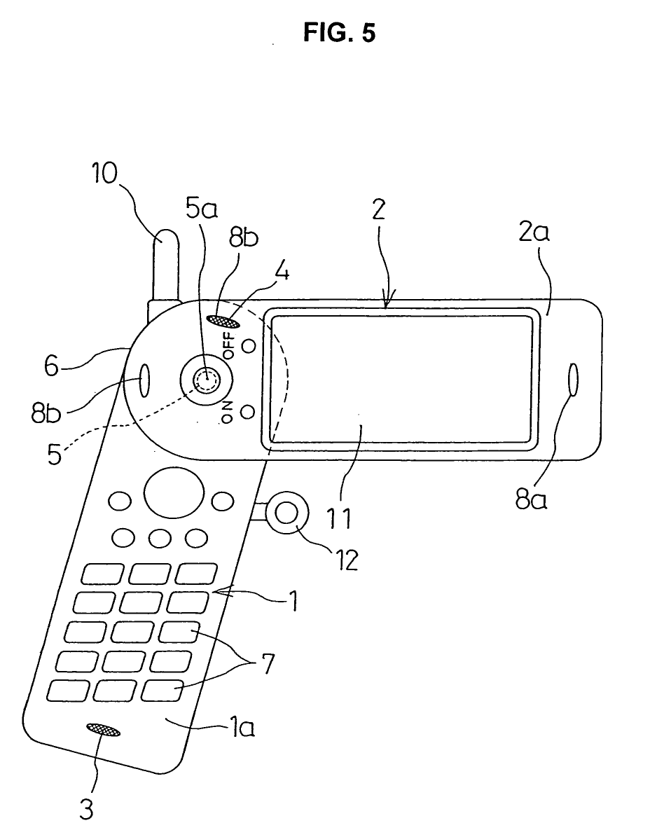

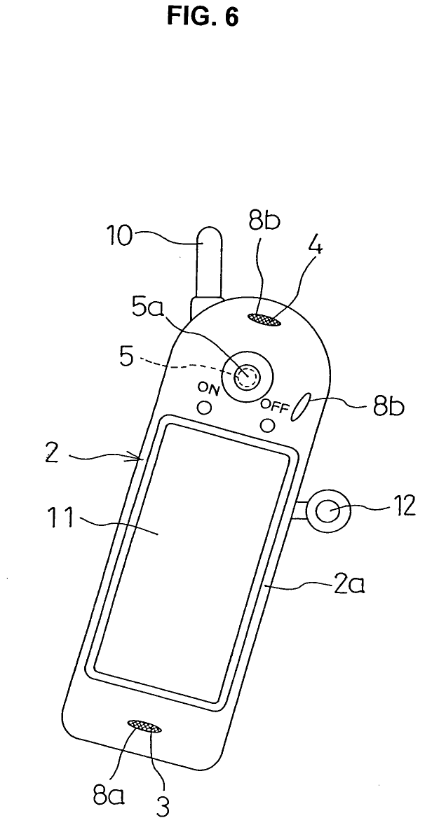

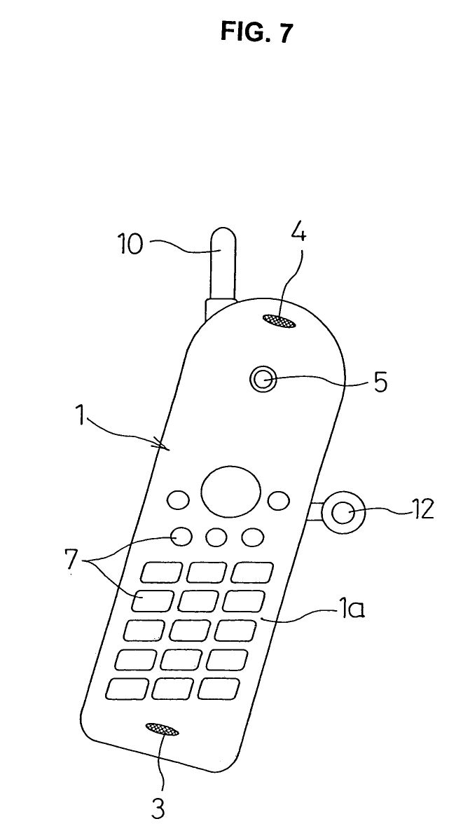

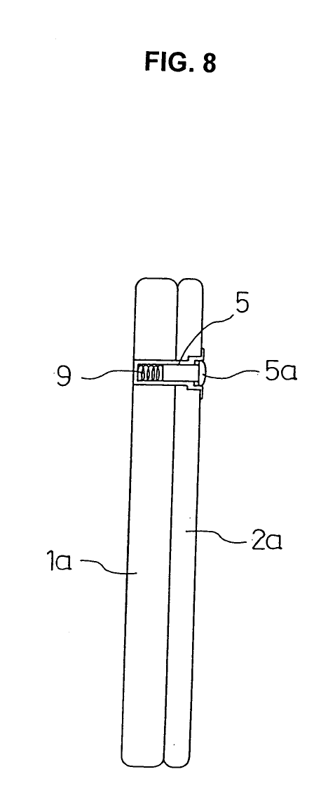

FIGS. 5 to 8 illustrate a second embodiment. In this embodiment, a display portion 2 overlaps with a keyboard portion 1 with its back contacting with the face of the latter. The display portion 2 is freely rotatably connected to the keyboard portion 1 via an axis 5 which is placed upwards on the display portion 2.

The axis 5 penetrates, in an antero-posterior direction, the display portion 2 and keyboard portion 1 overlapped with each other. As a consequence, the display portion 2 is rotatably connected via the rotational axis to the keyboard portion 1 such that a display panel on the display portion 2 changes its shape with respect to the keyboard portion 1 from a vertically elongated one when the two portions overlap with each other to a horizontally elongated one when the display portion is rotated 90° or more with respect to the keyboard portion.

The rotational joint around the axis 5 may have a structure similar to that of the first embodiment described above: an annular projection 14 with a central mortise 18 is inserted into a corresponding annular recess 15 with a central tenon 17 in such a way as to allow the central mortise to receive the central tenon, and a bolt 21 with a male thread supported by a circular seat 20 is screwed into a hole with a female thread formed along the central axis of the tenon.

The speech receiving portion 4 is placed upwards on the housing 1a carrying the keyboard portion 1, and operation buttons 7 forming the core of the keyboard portion 1 are arranged sufficiently low on the housing 1a to avoid the joint section. The housing 1a carrying the keyboard portion 1 often has terminals for charging a battery on its bottom end. When charging of a battery is required, it is advisable to rotate the display portion 2 with respect to the keyboard portion 1 by an angle as shown in FIG. 5 so that the device can stand upright.

The display portion 2 has through-holes 8a and 8b which correspond in position with the speech receiving portion 3 and speech delivering portion 4 formed on the keyboard portion 1, respectively. The through-holes 8b corresponding with the speech receiving portion 3 are two in number: one for the speech receiving portion 3 when the display portion 2 overlaps with the keyboard portion 1 with the display panel being vertically elongated, while the other for the speech receiving portion 3 when the display portion 2 is fully rotated with respect to the keyboard portion 1 so as to make the display panel horizontally elongated.

The rotational joint around the axis 5 incorporates a spring 9 for urging the rotation of the display portion 2, and a lock mechanism (not illustrated) which allows the display portion 2 to be locked when it completely overlaps with the keyboard portion 1, or when it is fully extended to a position where the display panel becomes horizontally elongated. The axis 5 may work in combination with the lock mechanism as follows: its head serves as a button switch 5a which, when depressed (activated), releases the lock mechanism.

Next, use of a portable telephone device representing the second embodiment will be described. When the user uses the device simply for talking with a third party on the other end of the line without manipulating operation buttons on the keyboard portion 1, e.g., he/she receives a call from a third party and talks with the third party using the device, the user can achieve the purpose by holding the device with the display portion 2 overlapping with the keyboard portion 1 keeping its display panel vertically extended, and by directing his/her voice towards the speech receiving portion 3 via the through-hole 8a, and listening to the voice from the third party transmitted by the speech delivering portion 4 via the through-hole 8b.

When the user wants to collect visual information via the display panel, he/she depresses the button switch 5a. Then, the lock mechanism is released, the display portion 2 is rotated 90° with respect to the keyboard portion 1 being driven by a force from the spring 9 and the LCD panel 11 becomes horizontally elongated as shown in FIG. 5. Thus, the user can have a wide screen before him/her for ready use.

If the user wants to return the display portion to the original position, he/she flexes by hand the extended display portion 2 towards the keyboard portion 1 until it overlaps with the latter.

Industrial Applicability

As described above, the portable telephone device of the invention allows the user to obtain a wide screen by taking simple procedures, i.e., to gain access to a visually desirable display panel without increasing the overall size of the device.

1. A portable telephone device comprising a display portion connected freely rotatably to a keyboard portion wherein:
the display portion overlaps with the keyboard portion partially or as a whole;
the display portion is rotatably connected via a rotational axis to the keyboard portion such that a display panel changes its shape with respect to the keyboard portion from a vertically elongated one to a horizontally elongated one and vice versa according to the rotation angle of the display portion with respect to the keyboard portion; and
when the display portion completely overlaps with the keyboard portion, the display panel is vertically elongated, and when only the proximal end of the display portion overlaps with the upper end of the keyboard portion via the rotational axis, the display panel is horizontally elongated.

2. A portable telephone device as described in claim 1 wherein:
operation buttons including ten keys of the keyboard portion are arranged in a matrix comprising vertical columns and horizontal rows; and
the buttons are arranged in horizontal rows such that a line connecting any one horizontal row of buttons forms an upward or downward slope with respect to the bottom line of the keyboard portion.

3. A portable telephone device as described in claim 1 or 2 wherein the display portion overlaps with the keyboard portion with its face contacting with the back of the latter, and the keyboard portion has a small display window for displaying a phone number or the like.

4. A portable telephone device as described in claim 1 or 2 wherein, when the display portion is rotated with respect to the keyboard portion to a position where the display panel becomes horizontally elongated, the two portions partially overlap with each other via a joint section, and the operation buttons of the keyboard portion are arranged towards the lower end of the keyboard portion to be sufficiently apart from the joint section.

5. A portable telephone device as described in any one of claims 1, 2 and 4 wherein a speech receiving portion is placed downwards on the keyboard portion, and a through-hole is formed distally on the display portion such that when the two portions completely overlap with each other, the speech receiving portion corresponds in position with the through-hole.

6. A portable telephone device as described in any one of claims 1, 2, 4 and 5 wherein:
the display portion is connected via a rotational axis to the keyboard portion such that, when the display portion overlaps with the keyboard portion, its face contacts with the back of the keyboard portion, and when the display portion is rotated around the rotational axis so as to cause the display panel to be horizontally elongated, overlapping is limited to a joint section; and
the display panel is placed sufficiently low on the display portion to be distinctly apart from the joint section.

7. A portable telephone device as described in any one of claims 1 to 6 wherein:
the display portion is connected to the keyboard portion via a rotational joint, the joint being formed by engaging an annular projection with a central mortise attached to either of the two portions with a corresponding annular recess with a central tenon formed on the other portion after placing the annular projection opposite to the annular recess and the central mortise to the central tenon respectively, and specifically the joint being formed by preparing a circular seat having an upright bolt with a male thread at its center, drilling a hole with a female thread through the central axis of the tenon, fitting the annular projection with the central mortise to the annular recess with the central tenon, placing the circular seat on the back of the display portion at a position opposite to the mortise such that the bolt faces the exposed opening of the hole, and screwing the bolt with a male thread into the hole with a female thread, so as to firmly fasten the display portion to the keyboard portion, and to allow the display portion to freely rotate with respect to the keyboard portion around the rotational axis of the joint.
